(19) United States
(12) Patent Application Publication
(10) Pub. No.: US 2015/0343618 A1
(43) Pub. Date: Dec. 3, 2015

(54) Torsion Bar

(71) Applicant: Hilti Aktiengesellschaft, Schaan (LI)

(72) Inventors: Matthias Wissling, St. Gallen (CH); Andreas Eckstein, Landsberg am Lech (DE); Robert Meier, Feldkirch (AT); Ralf Zitzmann, Feldkirch (AT)

(21) Appl. No.: 14/418,000

(22) PCT Filed: Jul. 24, 2013
(86) PCT No.: PCT/EP2013/065595

§ 371 Date: Jan. 28, 2015

(30) Foreign Application Priority Data
Jul. 31, 2012 (DE) 10 2012 213 432.8

(51) Int. Cl. B25B 23/00; B25B 13/06; B25B 21/02; B25G 1/10

(52) U.S. Cl. CPC B25B 23/0021; B25G 1/105; B25B 13/06; B25B 21/02

(57) ABSTRACT

A torsion bar for limiting torque, including a shank with a first end section and a second end section situated opposite from it in the lengthwise direction, also including a first coupler to non-rotatably join the shank to the driven spindle of an impact driver, whereby the first coupler is located on the first end section of the shank, and including a second coupler to non-rotatably join the shank to a threaded element, especially the nut of an expansion anchor, whereby the second coupler is arranged on the second end section of the shank, whereby the shank has at least one tapered torsion section in which the shank has a smaller cross section than in at least one of the end sections, characterized in that the shank has a plastic encapsulation, at least in the tapered torsion section.

The invention relates to a torsion bar for limiting torque. The torsion bar has a shank with a first end section and a second end section situated opposite therefrom in the lengthwise direction, it also has a first coupler to non-rotatably join the shank to the driven spindle of an impact driver, whereby the first coupler is located on the first end section of the shank, it also has a second coupler to non-rotatably join the shank to a threaded element, especially the nut of an expansion anchor, whereby the second coupler is arranged on the second end section of the shank, whereby the shank has at least one tapered torsion section in which the shank has a smaller cross section than in at least one of the end sections.

### BACKGROUND

A generic torsion bar is disclosed, for example, in British patent application GB 1521461 A. Such a torsion bar constitutes a torsion spring between the driven spindle of the impact driver and the screw element that is to be tightened, whereby said torsion spring can limit the torque applied to the screw element.

### SUMMARY OF THE INVENTION

It is an objective of the present invention to provide a torsion bar that is particularly reliable without involving a great deal of work.

The present invention provides a torsion bar having a shank that has a plastic encapsulation, at least in the tapered torsion section.

The invention is based on the realization that the tapered torsion section of the shank of the torsion bar is markedly deformed during normal operation. If a coating had been provided in this section as protection against corrosion, this could entail the risk of chipping since a coating—which is typically less ductile but adheres well to the substrate—cannot follow the movement of the substrate. This is where the invention comes in and provides for a plastic encapsulation instead of a coating. Such a plastic encapsulation can be created particularly easily with a relatively thick wall in addition to being relatively ductile and/or exhibiting relatively little adhesion to the substrate. Consequently, this very efficiently counters a failure of the protective layer. Owing to the relatively thick wall, plastic encapsulation can also serve to protect the comparatively sensitive tapered section especially well against mechanical effects.

The first coupler can have a polygonal structure, preferably a polygonal socket, for instance, a square. By the same token, the second coupler can have a polygonal structure, preferably a polygonal socket, for instance, a hexagon. The term “lengthwise direction” can especially refer to the direction of the longitudinal axis of the torsion bar and/or of the shank. The threaded element has a thread that especially runs coaxially to the torsion bar. The threaded element can have an external thread or an internal thread, and it can be a screw or a threaded nut. In particular, the threaded element can be the nut of an expansion anchor, that is to say, especially the nut of an anchor with an anchoring bolt and an expansion sleeve, whereby the anchoring bolt has an expansion cone to spread open the expansion sleeve and also a thread that is arranged on the nut.

Preferably, the shank has precisely one contiguous tapered torsion section, which can simplify the production work involved. Owing to the locally reduced cross section, the torsion is exerted onto the shank, at least primarily in the torsion section. Preferably, the tapered section of the shank has a smaller cross section than that of the two end sections. According to the invention, the term “plastic encapsulation” refers to the product obtained from an encapsulation process.

It is especially preferred if the plastic encapsulation is limited to a central section of the shank, especially to the tapered torsion section. According to this embodiment, the plastic encapsulation is systematically employed to protect the most sensitive zone. In contrast, at least the second end section—whose cross section is relatively large and on which the threaded element is arranged—remains free, so that the invention can be used even if there is only a small amount of space available on the threaded element, and so that this end section can also be manually secured during use. In other words, this also translates into a very broad application range while providing a high degree of reliability.

It is likewise preferred for the plastic encapsulation to be made of a thermoplastic. This is advantageous when it comes to the production work involved. The shank is preferably made of metal, especially of steel.

It can also be provided that the plastic encapsulation is made of an elastomer. Such an elastomer can absorb the deformation of the shank very well. For this reason, this embodiment translates into excellent strength, even if the plastic encapsulation adheres very strongly to the shank.

The shank can have a circular cross section in the torsion section and/or in at least one end section, preferably in both end sections, which can be advantageous in terms of the production work involved. The minimum diameter of the shank in the torsion section is preferably smaller than the minimum diameter of the shank in the end sections by at least a factor of 2, preferably by at least a factor of 3.

The tapered torsion section preferably has a segment where the shank has a constant cross section. Adjoining this segment, there can be transition areas, preferably on both sides, in which the shank cross section becomes larger, preferably continuously, towards each end section. It is especially preferred for the plastic encapsulation to extend at least beyond the segment having a constant shank cross section. The plastic encapsulation can also extend over the transition areas. The transition areas can, but do not have to, be seen as parts of the torsion section.

The segment where the shank has a constant cross section preferably has a circular or square cross section and can have the following dimensions:
a diameter of 5.4 mm and a length of 84 mm,
a diameter of 5.9 mm and a length of 42 mm,
a diameter of 7 mm and a length of 42 mm, or
a diameter of 7.7 mm and a length of 42 mm.

The invention also relates to an arrangement consisting of a torsion bar according to one of the preceding claims, an impact driver and an expansion anchor with a nut, whereby the torsion bar is non-rotatably coupled at its first coupler to a driven spindle of the impact driver, and at its second coupler, it is non-rotatably coupled to the nut of the expansion anchor.

### BRIEF DESCRIPTION OF THE DRAWINGS

The invention will be explained in greater detail below on the basis of preferred embodiments that are schematically shown in the accompanying figures. The figures shown the following schematically:

FIG. 1 a perspective view of a torsion bar according to the invention; and

FIG. 2 a longitudinal sectional view of the torsion bar of FIG. 1, with an impact driver and an expansion anchor.

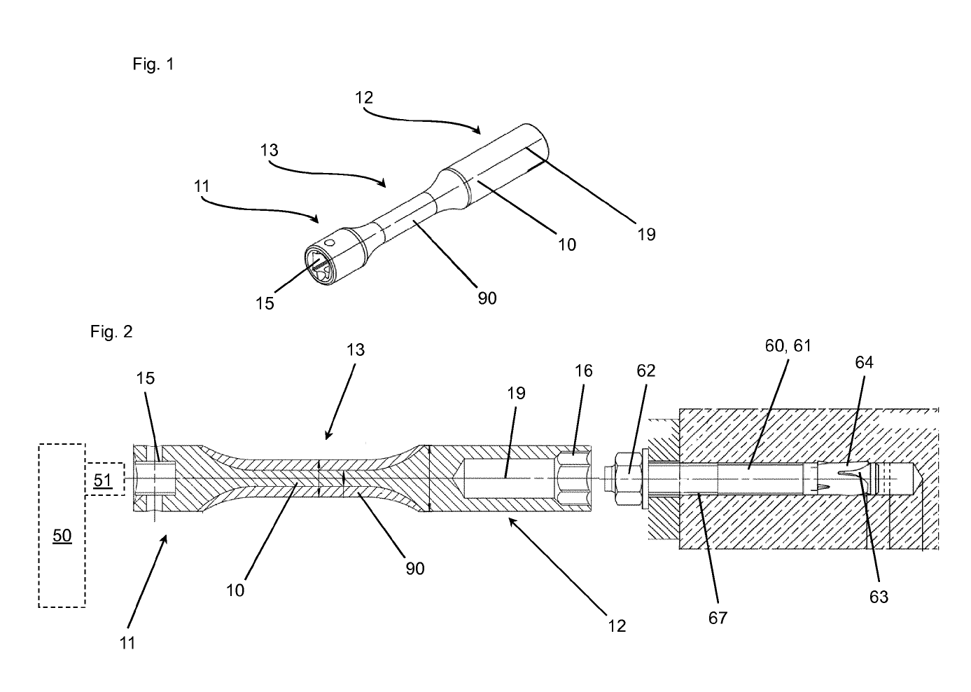

### DETAILED DESCRIPTION

The figures show an embodiment of a torsion bar according to the invention. The torsion bar has a shank 10 with a first end section 11 and an opposite second end section 12 in a lengthwise direction, in other words, in the direction of the lengthwise axis 19 of the shank 10. On the first end section 11, the end face of the shank 10 has a first coupler 15 configured as a polygonal socket by means of which the shank 10 can be non-rotatably coupled to the driven spindle 51 of an impact driver 50, especially a tangential impact driver, which is only shown in FIG. 2, merely in a simple schematic form. On the second end section 12, there is on the end face of the shank 10 a second coupler 16 configured as a hexagonal socket by means of which the shank 10 can be non-rotatably coupled to a threaded element 62 that is only shown in FIG. 2.

In particular, the torsion bar can serve to install the expansion anchor 60 shown in FIG. 2, which has an anchor bolt 61 and an expansion sleeve 64 surrounding the anchor bolt 61, whereby the anchor bolt 64 has, on the one hand, an expansion cone 63 for spreading open the expansion sleeve 64 and, on the other hand, a thread 67 that holds the threaded element 62 configured as a nut.

Between the two end sections 11 and 12, the shank 10 has a torsion section 13 in which the shank 10 has a smaller cross section in comparison to that of the end sections 11 and 12. When the torsion bar is properly used, this torsion section 13 acts as a torsion spring that can absorb forces stemming from the impact driver 50.

In the torsion section 13, the shank 10 is surrounded by a sleeve-like plastic encapsulation 90 that protects the torsion section 13. The plastic encapsulation 90 is limited to the torsion section 13 having the smaller cross section and it does not extend into the end sections 11 and 12, which can be polished or, for example, burnished.

What is claimed is:

1-5. (canceled)

6. A torsion bar for limiting torque comprising:
a shank having a first end section and a second end section situated opposite from the first end section in a lengthwise direction;
a first coupler to non-rotatably join the shank to a driven spindle of an impact driver, the first coupler located on the first end section of the shank; and
a second coupler to non-rotatably join the shank to a threaded element, the second coupler being arranged on the second end section of the shank,
the shank having at least one tapered torsion section, the shank having a smaller cross section in the tapered torsion section than in at least one of the first and second end sections, the shank having a plastic encapsulation, at least in the tapered torsion section.

7. The torsion bar as recited in claim 6 wherein the threaded element is a nut of an expansion anchor.

8. The torsion bar as recited in claim 6 wherein the plastic encapsulation is limited to a central section of the shank.

9. The torsion bar as recited in claim 8 wherein the plastic encapsulation is limited to the tapered torsion section.

10. The torsion bar as recited in claim 6 wherein the plastic encapsulation is made of a thermoplastic.

11. The torsion bar as recited in claim 6 wherein the tapered torsion section has a segment where the shank has a constant cross section, the plastic encapsulation extending at least beyond the segment having a constant shank cross section.

12. An arrangement comprising:
the torsion bar as recited in claim 6;
an impact driver; and
an expansion anchor having a nut, the first coupler of the torsion bar being non-rotatably coupled to a driven spindle of the impact driver while the second coupler is non-rotatably coupled to the nut of the expansion anchor.
